(19) United States
(12) Patent Application Publication
(10) Pub. No.: US 2012/0105237 A1
(43) Pub. Date: May 3, 2012

(54) SYSTEMS AND METHODS FOR MONITORING CONTAINERS BURIED IN AN ENCLOSED AREA

(76) Inventor: YAT WAI EDWIN KWONG, Hong Kong (HK)

(21) Appl. No.: 12/938,696

(22) Filed: Nov. 3, 2010

(51) Int. Cl. G08B 21/00

(52) U.S. Cl. 340/635

(57) ABSTRACT

Systems and methods are provided for monitoring an enclosed area. In accordance with one implementation, a system is provided that includes monitoring a container in an enclosed area such as a coffin in a cemetery. The container may be buried and covered by obstructing matter. The system also includes a control system that monitors buried subject matter in the enclosed area. Further, the system includes a GPS receiver that is associated with one of receiver status. The status includes a standby mode, a first warning mode, and a second warning mode.

### BACKGROUND

I. Technical Field

The present invention generally relates to the field of monitoring containers buried in an enclosed area. Specifically, and without limitation, the invention relates to systems and methods that wirelessly monitor buried containers such as coffins in cemeteries.

II. Background Information

In data communication, there is wired communication and wireless communication. Wireless communication refers to, transfer of information without using a physical medium between 2 locations. Specifically, in convention technologies, wireless communications are used extensively. Such uses, for example, include radio communication, cell phone mobility, personal digital assistants (PDA), and other types of wireless networking. Among others, GPS (Global Positioning System) is a global navigation satellite system providing low cost while reliable positioning, navigation, and timing services to worldwide users on a continuous basis in the world which has an unobstructed view of GPS satellites. A GPS device can be any physical device that communicates with GPS satellites. A GPS device is made in different form factors. Examples of a GPS device include a PDA with GPS navigation capabilities, a handheld device placed in cars with location functions, and a notebook that equipped with remote navigation features. A GPS device relies on an embedded GPS receiver to detect GPS signals from GPS satellites, and the general principle requires a GPS receiver to operate in unobstructed manners. For conventional use, a GPS device is usually placed outdoor. When the GPS device is buried in the ground, the GPS receiver embedded is obstructed by matter, such as soil, concrete, or even wood that covers the GPS device from above. Under such circumstances, the GPS device hiding below the ground level cannot be located by the global position system. Thus, the global position system loses track of the GPS device buried in the ground and cannot detect any physical movement of the GPS device.

In view of the foregoing, there is a need for systems and methods that monitor buried containers in an efficient manner. There is also a need for systems and methods that can reliably monitor containers in remote areas such as coffins in cemeteries. In addition, there is a need for a solution that permits monitoring buried subject matter inside a container.

### SUMMARY

Embodiments of the present invention relate to systems and methods for monitoring an enclosed area. Certain embodiments of the invention include a first GPS satellite, a second satellite, a third GPS satellite, a communication satellite, a monitored container that is buried in the enclosed area, a control system that monitors the monitored container, and a GPS receiver that includes a transmitter configured to send the satellite signals to the communication satellite.

Consistent with certain embodiments of the invention, in one embodiment, the enclosed area may include a cemetery and the monitored container is a coffin. In addition, the GPS receiver can be physically attached onto the surface of the monitored coffin and covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas in the standby mode, the GPS receiver attempts to receive GPS signals continuously, despite the GPS receiver being covered by the obstructing matter; in the first warning mode, where the obstructing matter has been removed, the GPS receiver successfully receives a first GPS signal from the GPS satellite, and sends a first satellite signal to the communication satellite to notify the control system regarding the removal of the obstructing matter; and in the second warning mode, where the GPS receiver and the attached monitored coffin has been moved to a new location, the GPS receiver may receive a second GPS signal from the GPS satellite, and send a second satellite signal to the communication satellite to notify the control system regarding the new location with respect to the GPS receiver and the attached monitored coffin.

In a different embodiment, the GPS receiver is physically attached inside the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas in the standby mode, the GPS receiver attempts to receive GPS signals continuously, despite the GPS receiver being covered by the coffin and the obstructing matter; in the first warning mode, where the obstructing matter has been removed, the coffin has been opened, the GPS receiver successfully receives a first GPS signal from the GPS satellite, and sends a first satellite signal to the communication satellite to notify the control system regarding the removal of the obstructing matter and the opening of the coffin; and in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin.

In yet another embodiment, in the standby mode, to save power, the GPS receiver may enter to sleep mode and attempts to receive GPS signals periodically, despite the GPS receiver being covered by the coffin and the obstructing matter; in the first warning mode, where the obstructing matter has been removed, the coffin has been opened, and the GPS receiver has woken up from the sleep mode, the GPS receiver may successfully receive a first GPS signal from the GPS satellite, and send a first satellite signal to the communication satellite to notify the control system regarding the removal of the obstructing matter and the opening of the coffin; and in the second warning mode, where the GPS receiver and the attached monitored coffin has been moved to a new location, the GPS receiver may receive a second GPS signal from the GPS satellite, and send a second satellite signal to the communication satellite to notify the control system regarding the new location with respect to the GPS receiver and the attached monitored coffin.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating an exemplary system, consistent with an embodiment of the present invention.

### DETAILED DESCRIPTION

Embodiments of the present invention relate to systems and methods for positioning cargo containers. Certain embodiments of the invention include a first GPS satellite, a second satellite, a third GPS satellite. A GPS satellite may send GPS signals to one or more GPS receivers.

Embodiments may include a communication satellite. Consistent with all embodiments, the communication satellite receives satellite signals from the GPS receivers and sends the satellite signals to control systems located on ground stations. In addition, embodiments may include a monitored container that is buried in the enclosed area and a control system that monitors the monitored container. The enclosed area may include a cemetery whereas the monitored container may be a coffin. In one embodiment, the control system can be configured to receive the satellite signals from the communication satellite, and to indicate status of the monitored container, the status of the monitored container including an offline mode, a standby mode, a first warning mode, and a second warning mode, the offline mode indicating that the monitored container has not been buried, the standby mode indicating that the monitored container has been buried, the first warning mode indicating that the obstructing matter above the monitored container has been removed, and the second warning mode indicating that the monitored container has been moved to a different location. In the embodiment, a GPS receiver may be included. The GPS receiver may further include a transmitter configured to send the satellite signals to the communication satellite.

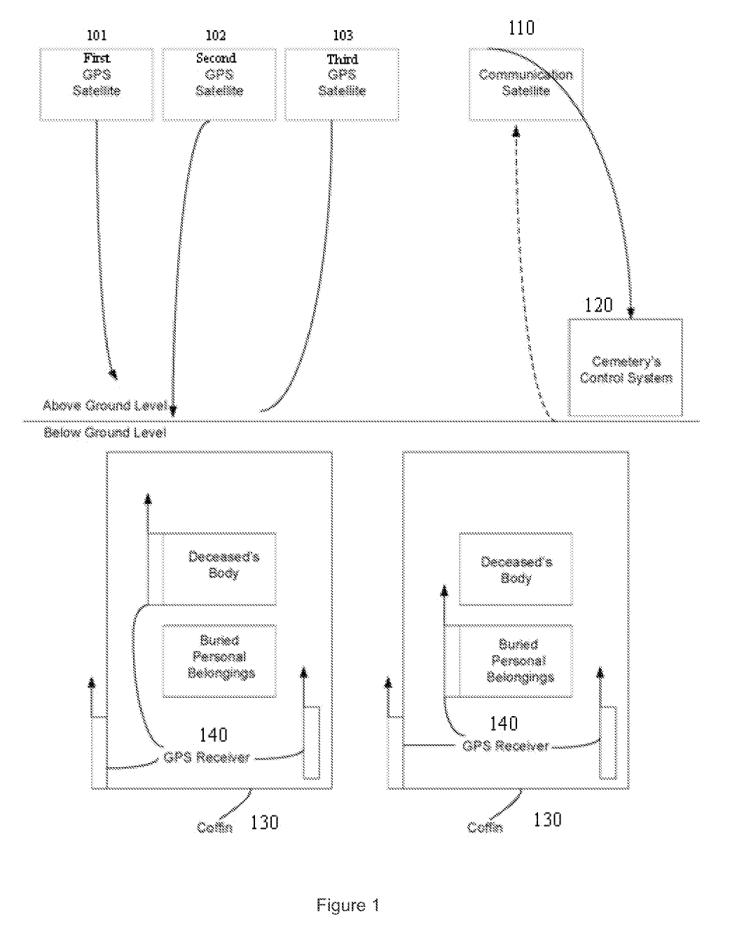

In one embodiment illustrated in FIG. 1, the GPS receiver may be physically attached onto the surface of the monitored coffin (130) and covered by obstructing matter that obstructs the GPS receiver (140) from receiving GPS signals from the first (101), second (102), and third (103) GPS Satellites, and the GPS receiver (140) is associated with one of receiver status, the status including the standby mode, the first warning mode, or the second warning mode, whereas in the standby mode, the GPS receiver (140) attempts to receive GPS signals continuously, despite the GPS receiver (140) being covered by the obstructing matter; in the first warning mode, where the obstructing matter has been removed, the GPS receiver (140) successfully receives a first GPS signal from the GPS satellite, and sends a first satellite signal to the communication satellite (120) to notify the control system regarding the removal of the obstructing matter; and in the second warning mode, where the GPS receiver (140) and the attached monitored coffin (130) has been moved to a new location, the GPS receiver (140) receives a second GPS signal from the GPS satellite, and sends a second satellite signal to the communication satellite (120) to notify the control system regarding the new location with respect to the GPS receiver (140) and the attached monitored coffin (130).

In a different embodiment, the GPS receiver (140) may be physically attached inside the monitored coffin (130) that is covered by obstructing matter that obstructs the GPS receiver (140) from receiving GPS signals from the first (101), second (102), and third (103) GPS Satellites, and the GPS receiver (140) may be associated with one of receiver status, the status including the standby mode, the first warning mode, or the second warning mode, whereas in the standby mode, the GPS receiver (140) attempts to receive GPS signals continuously, despite the GPS receiver (140) being covered by the coffin (130) and the obstructing matter; in the first warning mode, where the obstructing matter has been removed, the coffin (130) has been opened, the GPS receiver (140) successfully receives a first GPS signal from the GPS satellite, and sends a first satellite signal to the communication satellite (120) to notify the control system regarding the removal of the obstructing matter and the opening of the coffin (130); and in the second warning mode, where the GPS receiver (140) and the attached monitored coffin (130) has been moved to a new location, the GPS receiver (140) receives a second GPS signal from the GPS satellite, and sends a second satellite signal to the communication satellite (120) to notify the control system regarding the new location with respect to the GPS receiver (140) and the attached monitored coffin (130).

In an alternate embodiment, in the standby mode, to save power, the GPS receiver (140) enters to sleep mode and attempts to receive GPS signals periodically, despite the GPS receiver (140) being covered by the coffin (130) and the obstructing matter; in the first warning mode, where the obstructing matter has been removed, the coffin (130) has been opened, and the GPS receiver (140) has woken up from the sleep mode, the GPS receiver (140) successfully receives a first GPS signal from the GPS satellite, and sends a first satellite signal to the communication satellite (120) to notify the control system regarding the removal of the obstructing matter and the opening of the coffin (130); and in the second warning mode, where the GPS receiver (140) and the attached monitored coffin (130) has been moved to a new location, the GPS receiver (140) receives a second GPS signal from the GPS satellite, and sends a second satellite signal to the communication satellite (120) to notify the control system regarding the new location with respect to the GPS receiver (140) and the attached monitored coffin (130).

A monitored coffin (130) may contain buried subject matter. In that case, the GPS receiver (140) may be physically attached to the buried subject matter contained in the monitored coffin (130) that is covered by obstructing matter that obstructs the GPS receiver (140) from receiving GPS signals from the first (101), second (102), and third (103) GPS Satellites, and the GPS receiver (140) is associated with one of receiver status, the status including the standby mode, the first warning mode, or the second warning mode, whereas in the standby mode, the GPS receiver (140) attempts to receive GPS signals continuously, despite the GPS receiver (140) being covered by the coffin (130) and the obstructing matter; in the first warning mode, where the obstructing matter has been removed, the coffin (130) has been opened, the GPS receiver (140) successfully receives a first GPS signal from the GPS satellite, and sends a first satellite signal to the communication satellite (120) to notify the control system regarding the removal of the obstructing matter and the opening of the coffin (130); and in the second warning mode, where the GPS receiver (140) and the attached buried subject matter has been moved to a new location, the GPS receiver (140) receives a second GPS signal from the GPS satellite, and sends a second satellite signal to the communication satellite (120) to notify the control system regarding the new location with respect to the GPS receiver (140) and the attached buried subject matter.

Consistent with the above embodiment, in the standby mode, to save power, the GPS receiver (140) may instead enter to sleep mode and attempts to receive GPS signals periodically, despite the GPS receiver (140) being covered by the coffin (130) and the obstructing matter; in the first warning mode, where the obstructing matter has been removed, the coffin (130) has been opened, and the GPS receiver (140) has woken up from the sleep mode, the GPS receiver (140) successfully receives a first GPS signal from the GPS satellite, and sends a first satellite signal to the communication satellite (120) to notify the control system regarding the removal of the obstructing matter and the opening of the coffin (130); and in the second warning mode, where the GPS receiver (140) and the attached buried subject matter has been moved to a new location, the GPS receiver (140) receives a second GPS signal from the GPS satellite, and sends a second satellite signal to the communication satellite (120) to notify the control system regarding the new location with respect to the GPS receiver (140) and the attached buried subject matter.

Embodiments may also include an auxiliary GPS receiver (140). The auxiliary GPS receiver (140) to complement with the GPS receiver (140) at times where the auxiliary GPS receiver (140) is being obstructed from receiving the GPS signals, wherein the auxiliary GPS receiver (140) is physically attached onto the surface of the monitored coffin (130) and covered by obstructing matter that obstructs the auxiliary GPS receiver (140) from receiving GPS signals from the first (101), second (102), and third (103) GPS Satellites, and the auxiliary GPS receiver (140) is associated with one of receiver status, the status including the standby mode, the first warning mode, or the second warning mode, whereas in the standby mode, the auxiliary GPS receiver (140) attempts to receive GPS signals continuously, despite the auxiliary GPS receiver (140) being covered by the obstructing matter; in the first warning mode, where the obstructing matter has been removed, the auxiliary GPS receiver (140) successfully receives the first GPS signal from the GPS satellite, and sends the first satellite signal to the communication satellite (120) to notify the control system regarding the removal of the obstructing matter; and in the second warning mode, where the auxiliary GPS receiver (140) and the attached monitored coffin (130) has been moved to the new location, the auxiliary GPS receiver (140) receives the second GPS signal from the GPS satellite, and sends a second satellite signal to the communication satellite (120) to notify the control system regarding the new location with respect to the auxiliary GPS receiver (140) and the attached monitored coffin (130). The auxiliary GPS receiver (140) may be furthered to include a first, second, and a third auxiliary GPS. The first auxiliary GPS receiver (140) to complement with the GPS receiver (140) at times where the GPS receiver (140) is being obstructed from receiving the GPS signals, wherein the first auxiliary GPS receiver (140) is physically attached onto the surface of the monitored coffin (130) and covered by obstructing matter that obstructs the first auxiliary GPS receiver (140) from receiving GPS signals from the first (101), second (102), and third (103) GPS Satellites, and the first auxiliary GPS receiver (140) is associated with one of receiver status, the status including the standby mode, the first warning mode, or the second warning mode, whereas in the standby mode, the first auxiliary GPS receiver (140) attempts to receive GPS signals continuously, despite the first auxiliary GPS receiver (140) being covered by the obstructing matter; in the first warning mode, where the obstructing matter has been removed, the first auxiliary GPS receiver (140) successfully receives the first GPS signal from the GPS satellite, and sends the first satellite signal to the communication satellite (120) to notify the control system regarding the removal of the obstructing matter; and in the second warning mode, where the first auxiliary GPS receiver (140) and the attached monitored coffin (130) has been moved to the new location, the first auxiliary GPS receiver (140) receives the second GPS signal from the GPS satellite, and sends a second satellite signal to the communication satellite (120) to notify the control system regarding the new location with respect to the first auxiliary GPS receiver (140) and the attached monitored coffin (130). The second auxiliary GPS receiver (140) to complement with the GPS receiver (140) and the first auxiliary GPS receiver (140) at times where the GPS receiver (140) and the first auxiliary GPS receiver (140) are being obstructed from receiving the GPS signals, wherein the second auxiliary GPS receiver (140) is physically attached onto the surface of the monitored coffin (130) and covered by obstructing matter that obstructs the second auxiliary GPS receiver (140) from receiving GPS signals from the first (101), second (102), and third (103) GPS Satellites, and the second auxiliary GPS receiver (140) is associated with one of receiver status, the status including the standby mode, the first warning mode, or the second warning mode, whereas in the standby mode, to save power, the second auxiliary GPS receiver (140) enters to sleep mode and attempts to receive GPS signals periodically, despite the second auxiliary GPS receiver (140) being covered by the obstructing matter; in the first warning mode, where the obstructing matter has been removed and the second auxiliary GPS receiver (140) has woken up from the sleep mode, the second auxiliary GPS receiver (140) successfully receives a first GPS signal from the GPS satellite, and sends a first satellite signal to the communication satellite (120) to notify the control system regarding the removal of the obstructing matter; and in the second warning mode, where the second auxiliary GPS receiver (140) and the attached monitored coffin (130) has been moved to a new location, the second auxiliary GPS receiver (140) receives a second GPS signal from the GPS satellite, and sends a second satellite signal to the communication satellite (120) to notify the control system regarding the new location with respect to the second auxiliary GPS receiver (140) and the attached monitored coffin (130). The third auxiliary GPS receiver (140) to complement with the GPS receiver (140), the first auxiliary GPS receiver (140), and the second auxiliary GPS receiver (140) at times where the GPS receiver (140), the first auxiliary GPS receiver (140), and the second auxiliary GPS receiver (140) are being obstructed from receiving the GPS signals, wherein the third auxiliary GPS receiver (140) is physically attached inside the monitored coffin (130) that is covered by obstructing matter that obstructs the third auxiliary GPS receiver (140) from receiving GPS signals from the first (101), second (102), and third (103) GPS Satellites, and the third auxiliary GPS receiver (140) is associated with one of receiver status, the status including the standby mode, the first warning mode, or the second warning mode, whereas in the standby mode, the third auxiliary GPS receiver (140) attempts to receive GPS signals continuously, despite the third auxiliary GPS receiver (140) being covered by the coffin (130) and the obstructing matter; in the first warning mode, where the obstructing matter has been removed, the coffin (130) has been opened, the third auxiliary GPS receiver (140) successfully receives a first GPS signal from the GPS satellite, and sends a first satellite signal to the communication satellite (120) to notify the control system regarding the removal of the obstructing matter and the opening of the coffin (130); and in the second warning mode, where the third auxiliary GPS receiver (140) and the attached monitored coffin (130) has been moved to a new location, the third auxiliary GPS receiver (140) receives a second GPS signal from the GPS satellite, and sends a second satellite signal to the communication satellite (120) to notify the control system regarding the new location with respect to the third auxiliary GPS receiver (140) and the attached monitored coffin (130).

The present techniques and embodiments described herein, including the exemplary systems and methods presented above, can be implemented in digital electronic circuitry, or in computer hardware, firmware, software, or in any suitable combinations thereof. In addition, apparatus and systems consistent with the present invention can be implemented in a computer program product tangibly embodied in a machine-readable storage device for execution by a programmable processor.

The present techniques and embodiments described herein, including the exemplary systems and methods presented above, can be implemented in digital electronic circuitry, or in computer hardware, firmware, software, or in any suitable combinations thereof. In addition, apparatus and systems consistent with the present invention can be implemented in a computer program product tangibly embodied in a machine-readable storage device for execution by a programmable processor.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. A wireless communication system for monitoring an enclosed area, comprising
a first GPS satellite, a second satellite, and a third GPS satellite, wherein the first, second, and third GPS satellites send GPS signals to GPS receivers;
a communication satellite, wherein the communication satellite receives satellite signals from the GPS receivers and send the satellite signals to control systems located on ground stations;
a monitored container that is buried in the enclosed area;
a control system that monitors the monitored container, wherein:
the control system is configured to receive the satellite signals from the communication satellite, and to indicate status of the monitored container, the status of the monitored container including an offline mode, a standby mode, a first warning mode, and a second warning mode,
the offline mode indicating that the monitored container has not been buried,
the standby mode indicating that the monitored container has been buried,
the first warning mode indicating that the obstructing matter above the monitored container has been removed, and
the second warning mode indicating that the monitored container has been moved to a different location; and
a GPS receiver that includes a transmitter configured to send the satellite signals to the communication satellite.

2. The system of claim 1, wherein the enclosed area is a cemetery and the monitored container is a coffin, and wherein the GPS receiver is physically attached onto the surface of the monitored coffin and covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the obstructing matter;
in the first warning mode, where the obstructing matter has been removed, the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin.

3. The system of claim 1, wherein the enclosed area is a cemetery and the monitored container is a coffin, and wherein the GPS receiver is physically attached inside the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the coffin and the obstructing matter;
in the first warning mode, where the obstructing matter has been removed, the coffin has been opened, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin.

4. The system of claim 1, wherein the enclosed area is a cemetery and the monitored container is a coffin, and wherein the GPS receiver is physically attached inside the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, to save power, the GPS receiver enters to sleep mode and attempts to receive GPS signals periodically, despite the GPS receiver being covered by the coffin and the obstructing matter;
in the first warning mode, where the obstructing matter has been removed, the coffin has been opened, and the GPS receiver has woken up from the sleep mode, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin.

5. The system of claim 1, wherein the enclosed area is a cemetery and the monitored container is a coffin, wherein the monitored coffin contains buried subject matter, and wherein the GPS receiver is physically attached to the buried subject matter contained in the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the coffin and the obstructing matter;
in the first warning mode, where the obstructing matter has been removed, the coffin has been opened, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached buried subject matter has been moved to a new location, the GPS receiver receives a second GPS signal from the GPS satellite, and sends a second satellite signal to the communication satellite to notify the control system regarding the new location with respect to the GPS receiver and the attached buried subject matter.

6. The system of claim 1, wherein the enclosed area is a cemetery and the monitored container is a coffin, wherein the monitored coffin contains buried subject matter, and wherein the GPS receiver is physically attached to the buried subject matter contained in the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, to save power, the GPS receiver enters to sleep mode and attempts to receive GPS signals periodically, despite the GPS receiver being covered by the coffin and the obstructing matter;
in the first warning mode, where the obstructing matter has been removed, the coffin has been opened, and the GPS receiver has woken up from the sleep mode, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached buried subject matter has been moved to a new location, the GPS receiver receives a second GPS signal from the GPS satellite, and sends a second satellite signal to the communication satellite to notify the control system regarding the new location with respect to the GPS receiver and the attached buried subject matter.

7. The system of claim 1, wherein:
the enclosed area is a cemetery and the monitored container is a coffin,
the GPS receiver is physically attached onto the surface of the monitored coffin and covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the obstructing matter;
in the first warning mode, where the obstructing matter has been removed, the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin; and
the system further comprises
an auxiliary GPS receiver to complement with the GPS receiver at times where the auxiliary GPS receiver is being obstructed from receiving the GPS signals, wherein the auxiliary GPS receiver is physically attached onto the surface of the monitored coffin and covered by obstructing matter that obstructs the auxiliary GPS receiver from receiving GPS signals from the first, second, and third GPS satellites, and the auxiliary GPS receiver is associated with one of receiver status, the status including the standby mode, the first warning mode, or the second warning mode, whereas:
in the standby mode, the auxiliary GPS receiver attempts to receive GPS signals continuously, despite the auxiliary GPS receiver being covered by the obstructing matter;
in the first warning mode, where the obstructing matter has been removed, the auxiliary GPS receiver successfully receives the first GPS signal from the GPS satellite, and sends the first satellite signal to the communication satellite to notify the control system regarding the removal of the obstructing matter; and
in the second warning mode, where the auxiliary GPS receiver and the attached monitored coffin has been moved to the new location, the auxiliary GPS receiver receives the second GPS signal from the GPS satellite, and sends a second satellite signal to the communication satellite to notify the control system regarding the new location with respect to the auxiliary GPS receiver and the attached monitored coffin.

8. The system of claim 1, wherein:
the enclosed area is a cemetery and the monitored container is a coffin;
the GPS receiver is physically attached onto the surface of the monitored coffin and covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, to save power, the GPS receiver enters to sleep mode and attempts to receive GPS signals periodically, despite the GPS receiver being covered by the obstructing matter;
in the first warning mode, where the obstructing matter has been removed and the GPS receiver has woken up from the sleep mode, the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin; and
the system further comprises
an auxiliary GPS receiver to complement with the GPS receiver at times where the auxiliary GPS receiver is being obstructed from receiving the GPS signals, wherein the auxiliary GPS receiver is physically attached onto the surface of the monitored coffin and covered by obstructing matter that obstructs the auxiliary GPS receiver from receiving GPS signals from the first, second, and third GPS satellites, and the auxiliary GPS receiver is associated with one of receiver status, the status including the standby mode, the first warning mode, or the second warning mode, whereas:
in the standby mode, to save power, the auxiliary GPS receiver enters to sleep mode and attempts to receive GPS signals periodically, despite the auxiliary GPS receiver being covered by the obstructing matter;
in the first warning mode, where the obstructing matter has been removed and the auxiliary GPS receiver has woken up from the sleep mode, the auxiliary GPS receiver successfully receives a first GPS signal from the GPS satellite, and sends a first satellite signal to the communication satellite to notify the control system regarding the removal of the obstructing matter; and
in the second warning mode, where the auxiliary GPS receiver and the attached monitored coffin has been moved to a new location, the auxiliary GPS receiver receives a second GPS signal from the GPS satellite, and sends a second satellite signal to the communication satellite to notify the control system regarding the new location with respect to the auxiliary GPS receiver and the attached monitored coffin.

9. The system of claim 1, wherein:
the enclosed area is a cemetery and the monitored container is a coffin;
the GPS receiver is physically attached inside the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the coffin and the obstructing matter;
in the first warning mode, where the obstructing matter has been removed, the coffin has been opened, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin; and
the system further comprises an auxiliary GPS receiver to complement with the GPS receiver at times where the auxiliary GPS receiver is being obstructed from receiving the GPS signals, wherein the auxiliary GPS receiver is physically attached inside the monitored coffin that is covered by obstructing matter that obstructs the auxiliary GPS receiver from receiving GPS signals from the first, second, and third GPS satellites, and the auxiliary GPS receiver is associated with one of receiver status, the status including the standby mode, the first warning mode, or the second warning mode, whereas:
in the standby mode, the auxiliary GPS receiver attempts to receive GPS signals continuously, despite the auxiliary GPS receiver being covered by the coffin and the obstructing matter;
in the first warning mode, where the obstructing matter has been removed, the coffin has been opened, the auxiliary GPS receiver successfully receives a first GPS signal from the GPS satellite, and sends a first satellite signal to the communication satellite to notify the control system regarding the removal of the obstructing matter and the opening of the coffin; and
in the second warning mode, where the auxiliary GPS receiver and the attached monitored coffin has been moved to a new location, the auxiliary GPS receiver receives a second GPS signal from the GPS satellite, and sends a second satellite signal to the communication satellite to notify the control system regarding the new location with respect to the auxiliary GPS receiver and the attached monitored coffin.

10. The system of claim 1, wherein:
the enclosed area is a cemetery and the monitored container is a coffin;
the GPS receiver is physically attached inside the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, to save power, the GPS receiver enters to sleep mode and attempts to receive GPS signals periodically, despite the GPS receiver being covered by the coffin and the obstructing matter;
in the first warning mode, where the obstructing matter has been removed, the coffin has been opened, and the GPS receiver has woken up from the sleep mode, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin; and
the system further comprises an auxiliary GPS receiver to complement with the GPS receiver at times where the auxiliary GPS receiver is being obstructed from receiving the GPS signals, wherein the auxiliary GPS receiver is physically attached inside the monitored coffin that is covered by obstructing matter that obstructs the auxiliary GPS receiver from receiving GPS signals from the first, second, and third GPS satellites, and the auxiliary GPS receiver is associated with one of receiver status, the status including the standby mode, the first warning mode, or the second warning mode, whereas:
in the standby mode, to save power, the auxiliary GPS receiver enters to sleep mode and attempts to receive GPS signals periodically, despite the auxiliary GPS receiver being covered by the coffin and the obstructing matter;
in the first warning mode, where the obstructing matter has been removed, the coffin has been opened, and the auxiliary GPS receiver has woken up from the sleep mode, the auxiliary GPS receiver successfully receives a first GPS signal from the GPS satellite, and sends a first satellite signal to the communication satellite to notify the control system regarding the removal of the obstructing matter and the opening of the coffin; and
in the second warning mode, where the auxiliary GPS receiver and the attached monitored coffin has been moved to a new location, the auxiliary GPS receiver receives a second GPS signal from the GPS satellite, and sends a second satellite signal to the communication satellite to notify the control system regarding the new location with respect to the auxiliary GPS receiver and the attached monitored coffin.

11. The system of claim 1, wherein
the enclosed area is a cemetery and the monitored container is a coffin;
the monitored coffin contains buried subject matter;
the GPS receiver is physically attached to the buried subject matter contained in the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the coffin and the obstructing matter;
in the first warning mode, where the obstructing matter has been removed, the coffin has been opened, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached buried subject matter has been moved to a new location, the GPS receiver receives a second GPS signal from the GPS satellite, and sends a second satellite signal to the communication satellite to notify the control system regarding the new location with respect to the GPS receiver and the attached buried subject matter; and
the system further comprises an auxiliary GPS receiver to complement with the GPS receiver at times where the auxiliary GPS receiver is being obstructed from receiving the GPS signals, wherein the auxiliary GPS receiver is physically attached to the buried subject matter contained in the monitored coffin that is covered by obstructing matter that obstructs the auxiliary GPS receiver from receiving GPS signals from the first, second, and third GPS satellites, and the auxiliary GPS receiver is associated with one of receiver status, the status including the standby mode, the first warning mode, or the second warning mode, whereas:
in the standby mode, the auxiliary GPS receiver attempts to receive GPS signals continuously, despite the auxiliary GPS receiver being covered by the coffin and the obstructing matter;
in the first warning mode, where the obstructing matter has been removed, the coffin has been opened, the auxiliary GPS receiver successfully receives a first GPS signal from the GPS satellite, and sends a first satellite signal to the communication satellite to notify the control system regarding the removal of the obstructing matter and the opening of the coffin; and
in the second warning mode, where the auxiliary GPS receiver and the attached buried subject matter has been moved to a new location, the auxiliary GPS receiver receives a second GPS signal from the GPS satellite, and sends a second satellite signal to the communication satellite to notify the control system regarding the new location with respect to the auxiliary GPS receiver and the attached buried subject matter.

12. The system of claim 1, wherein
the enclosed area is a cemetery and the monitored container is a coffin;
the monitored coffin contains buried subject matter;
the GPS receiver is physically attached to the buried subject matter contained in the monitored coffin that is covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, to save power, the GPS receiver enters to sleep mode and attempts to receive GPS signals periodically, despite the GPS receiver being covered by the coffin and the obstructing matter;
in the first warning mode, where the obstructing matter has been removed, the coffin has been opened, and the GPS receiver has woken up from the sleep mode, the GPS receiver successfully receives a first GPS signal from the GPS satellite, and sends a first satellite signal to the communication satellite to notify the control system regarding the removal of the obstructing matter and the opening of the coffin; and
in the second warning mode, where the GPS receiver and the attached buried subject matter has been moved to a new location, the GPS receiver receives a second GPS signal from the GPS satellite, and sends a second satellite signal to the communication satellite to notify the control system regarding the new location with respect to the GPS receiver and the attached buried subject matter; and
the system further comprises:
an auxiliary GPS receiver to complement with the GPS receiver at times where the auxiliary GPS receiver is being obstructed from receiving the GPS signals, wherein the auxiliary GPS receiver is physically attached to the buried subject matter contained in the monitored coffin that is covered by obstructing matter that obstructs the auxiliary GPS receiver from receiving GPS signals from the first, second, and third GPS satellites, and the auxiliary GPS receiver is associated with one of receiver status, the status including the standby mode, the first warning mode, or the second warning mode, whereas:
in the standby mode, to save power, the auxiliary GPS receiver enters to sleep mode and attempts to receive GPS signals periodically, despite the auxiliary GPS receiver being covered by the coffin and the obstructing matter;
in the first warning mode, where the obstructing matter has been removed, the coffin has been opened, and the auxiliary GPS receiver has woken up from the sleep mode, the auxiliary GPS receiver successfully receives a first GPS signal from the GPS satellite, and sends a first satellite signal to the communication satellite to notify the control system regarding the removal of the obstructing matter and the opening of the coffin; and
in the second warning mode, where the auxiliary GPS receiver and the attached buried subject matter has been moved to a new location, the auxiliary GPS receiver receives a second GPS signal from the GPS satellite, and sends a second satellite signal to the communication satellite to notify the control system regarding the new location with respect to the auxiliary GPS receiver and the attached buried subject matter.

13. The system of claim 1, wherein
the enclosed area is a cemetery and the monitored container is a coffin;
the GPS receiver is physically attached onto the surface of the monitored coffin and covered by obstructing matter that obstructs the GPS receiver from receiving GPS signals from the first, second, and third GPS satellites, and the GPS receiver is associated with one of receiver status, the status including the standby mode, the first warning mode, or the second warning mode, whereas:
in the standby mode, the GPS receiver attempts to receive GPS signals continuously, despite the GPS receiver being covered by the obstructing matter;
in the first warning mode, where the obstructing matter has been removed, the GPS receiver successfully receives a first GPS signal from the GPS satellite, and sends a first satellite signal to the communication satellite to notify the control system regarding the removal of the obstructing matter; and
in the second warning mode, where the GPS receiver and the attached monitored coffin has been moved to a new location, the GPS receiver receives a second GPS signal from the GPS satellite, and sends a second satellite signal to the communication satellite to notify the control system regarding the new location with respect to the GPS receiver and the attached monitored coffin; and
the system further comprises:
a first auxiliary GPS receiver to complement with the GPS receiver at times where the GPS receiver is being obstructed from receiving the GPS signals, wherein the first auxiliary GPS receiver is physically attached onto the surface of the monitored coffin and covered by obstructing matter that obstructs the first auxiliary GPS receiver from receiving GPS signals from the first, second, and third GPS satellites, and the first auxiliary GPS receiver is associated with one of receiver status, the status including the standby mode, the first warning mode, or the second warning mode, whereas:
in the standby mode, the first auxiliary GPS receiver attempts to receive GPS signals continuously, despite the first auxiliary GPS receiver being covered by the obstructing matter;
in the first warning mode, where the obstructing matter has been removed, the first auxiliary GPS receiver successfully receives the first GPS signal from the GPS satellite, and sends the first satellite signal to the communication satellite to notify the control system regarding the removal of the obstructing matter; and
in the second warning mode, where the first auxiliary GPS receiver and the attached monitored coffin has been moved to the new location, the first auxiliary GPS receiver receives the second GPS signal from the GPS satellite, and sends a second satellite signal to the communication satellite to notify the control system regarding the new location with respect to the first auxiliary GPS receiver and the attached monitored coffin;
a second auxiliary GPS receiver to complement with the GPS receiver and the first auxiliary GPS receiver at times where the GPS receiver and the first auxiliary GPS receiver are being obstructed from receiving the GPS signals, wherein the second auxiliary GPS receiver is physically attached onto the surface of the monitored coffin and covered by obstructing matter that obstructs the second auxiliary GPS receiver from receiving GPS signals from the first, second, and third GPS satellites, and the second auxiliary GPS receiver is associated with one of receiver status, the status including the standby mode, the first warning mode, or the second warning mode, whereas:
in the standby mode, to save power, the second auxiliary GPS receiver enters to sleep mode and attempts to receive GPS signals periodically, despite the second auxiliary GPS receiver being covered by the obstructing matter;
in the first warning mode, where the obstructing matter has been removed and the second auxiliary GPS receiver has woken up from the sleep mode, the second auxiliary GPS receiver successfully receives a first GPS signal from the GPS satellite, and sends a first satellite signal to the communication satellite to notify the control system regarding the removal of the obstructing matter; and
in the second warning mode, where the second auxiliary GPS receiver and the attached monitored coffin has been moved to a new location, the second auxiliary GPS receiver receives a second GPS signal from the GPS satellite, and sends a second satellite signal to the communication satellite to notify the control system regarding the new location with respect to the second auxiliary GPS receiver and the attached monitored coffin; and
an third auxiliary GPS receiver to complement with the GPS receiver, the first auxiliary GPS receiver, and the second auxiliary GPS receiver at times where the GPS receiver, the first auxiliary GPS receiver, and the second auxiliary GPS receiver are being obstructed from receiving the GPS signals, wherein the third auxiliary GPS receiver is physically attached inside the monitored coffin that is covered by obstructing matter that obstructs the third auxiliary GPS receiver from receiving GPS signals from the first, second, and third GPS satellites, and the third auxiliary GPS receiver is associated with one of receiver status, the status including the standby mode, the first warning mode, or the second warning mode, whereas:
in the standby mode, the third auxiliary GPS receiver attempts to receive GPS signals continuously, despite the third auxiliary GPS receiver being covered by the coffin and the obstructing matter;
in the first warning mode, where the obstructing matter has been removed, the coffin has been opened, the third auxiliary GPS receiver successfully receives a first GPS signal from the GPS satellite, and sends a first satellite signal to the communication satellite to notify the control system regarding the removal of the obstructing matter and the opening of the coffin; and
in the second warning mode, where the third auxiliary GPS receiver and the attached monitored coffin has been moved to a new location, the third auxiliary GPS receiver receives a second GPS signal from the GPS satellite, and sends a second satellite signal to the communication satellite to notify the control system regarding the new location with respect to the third auxiliary GPS receiver and the attached monitored coffin.
